(19) United States
(12) Patent Application Publication
(10) Pub. No.: US 2018/0196895 A1
(43) Pub. Date: Jul. 12, 2018

(54) REUSABLE PRODUCT DESIGN MODEL

(71) Applicant: Benjamin James Joseph Soppitt, Mills Valley, CA (US)

(72) Inventor: Benjamin James Joseph Soppitt, Mills Valley, CA (US)

(21) Appl. No.: 15/403,732

(22) Filed: Jan. 11, 2017

(51) Int. Cl. G06F 17/50; G08B 21/18

(52) U.S. Cl. CPC G06F 17/5009; G08B 21/182

(57) ABSTRACT

A reusable product design methodology is disclosed. The method may include: receiving data representing user feedback from a group of users regarding a plurality of features, the plurality of features associated with characteristics of the group of users, and determining values associated with each of the plurality of features based on the data. The method may also include receiving a first set of product design components, outputting a first subset of the values, the first subset of the values being selected based on the first set of product design components, receiving a second set of product design components, and outputting a second subset of the values, the second subset of the values being selected based on the second set of product design components.

### CROSS-REFERENCES TO RELATED APPLICATIONS

None.

### BACKGROUND

Traditionally, the process of designing a product that is targeted towards a specific segment of the population involves first designing the product and then conducting research to determine whether the target segment responds positively to the product. For example, when a company attempts to design product that resonates with millennials, the company may first prototype the product and then present the prototype to a representative group of millennials to determine whether the product will do well towards millennials. If the resulting feedback indicates that the focus group finds the prototype highly desirable, the product may be moved into production.

However, if the resulting feedback indicates that the focus group does not find the prototype to be desirable, the product may be redesigned or abandoned. As a result, at least some of the effort that went into designing and producing the prototype may be wasted. Additionally, because feedback gathering efforts take may take a substantial amount of time (e.g., months), this problem may be especially pronounced in companies that have short time frames for designing products (e.g., advertising companies).

Embodiments of the invention address these and other problems.

### BRIEF SUMMARY

Embodiments of the invention are directed to methods and systems for improved product design. More specifically, embodiments of the invention are directed to techniques for generating a product design model based on user characteristics and using the product design model to design multiple products for users that have those characteristics.

For example, feedback regarding “features” (i.e., aspects, experiences, perceptions) associated with a product may be obtained from a group that is representative of a particular segment of the population. The feedback may contain information describing how important the population segment considers each of the features to be. A server computer may analyze the feedback regarding the product-associated features to determine values for each of the features, where the values represent how much importance the population segment places on each of the features. The server computer then uses the combination of the features and their associated values as a product design model to determine whether a proposed product having a set of product design components would be desirable to a member of the population segment. In particular, the server computer may determine that due to the set of product design components included in the proposed product, the product would provide a first subset of the features and fail to provide a second subset of the features. The server computer then determines a set of values based on which features are provided by the proposed product. The set of values could then be used in determining whether to put the proposed product into production.

One embodiment of the invention is directed to a method. The method can comprise: receiving, by a processor, data representing user feedback from a group of users regarding a plurality of features, the plurality of features associated with characteristics of the group of users; determining, by the processor, values associated with each of the plurality of features based on the data; receiving, by the processor, a first set of product design components; outputting, using the processor, a first subset of the values, the first subset of the values being selected based on the first set of product design components; receiving, by the processor, a second set of product design components; and outputting, using the processor, a second subset of the values, the second subset of the values being selected based on the second set of product design components.

Another embodiment of the invention is directed to a method. The method can comprise: displaying, to a user, a plurality of features, wherein the plurality of features are associated with characteristics of a group of users and each of the plurality of features is associated with a value based on data representing user feedback from the group of users; receiving, from the user, one or more selections of the plurality of features on behalf of a set of one or more product design components; determining, based on the values associated with the one or more selected features, a score for the set of one or more product design components; determining whether the score exceeds a threshold score; responsive to determining that the score exceeds the threshold score, generating an alert that identifies the set of one or more product design components.

These and other embodiments of the invention are described in detail below. For example, embodiments are directed to systems and computer readable media associated with methods described herein.

### BRIEF DESCRIPTION OF THE DRAWINGS

FIG. 1 illustrates a high-level block diagram of an environment in accordance with embodiments.

FIG. 2 illustrates a block diagram of configurator system in accordance with embodiments.

FIG. 3 shows a flowchart illustrating an exemplary method of generating and using a product design model in accordance with embodiments.

FIG. 4 shows a flowchart illustrating an exemplary method of using an interactive product design model in accordance with embodiments

### TERMS

Before discussing specific embodiments and examples, some descriptions of terms used herein are provided below.

A “server computer” may include any suitable computer that can provide communications to other computers and receive communications from other computers. A server computer may include a computer or cluster of computers. For instance, a server computer can be a mainframe, a minicomputer cluster, or a group of servers functioning as a unit. In one example, a server computer may be a database server coupled to a Web server. A server computer may be coupled to a database and may include any hardware, software, other logic, or combination of the preceding for servicing the requests from one or more client computers. A server computer may comprise one or more computational apparatuses and may use any of a variety of computing structures, arrangements, and compilations for servicing the requests from one or more client computers. Data transfer and other communications between components such as computers may occur via any suitable wired or wireless network, such as the Internet or private networks.

A “processor” may include hardware within a server computer (or other computing device) that carries out instructions embodied as code in a computer-readable medium. An exemplary processor may be a central processing unit (CPU). As used herein, a processor can include a single-core processor, a plurality of single-core processors, a multi-core processor, a plurality of multi-core processors, or any other suitable combination of hardware configured to perform arithmetical, logical, and/or input/output operations of a computing device

A “portable transaction device” may be a portable device that can be used to conduct a transaction. A portable transaction device may include a storage technology (e.g., electronic memory, magnetic stripe, etc.) to store credentials or tokens associated with an account of a user. A portable transaction device can be in any of the forms described above with respect to the portable communication device, or in the form of a card (e.g., integrated chip card, magnetic stripe card) or a fob, etc. In some embodiments, the portable transaction device and the portable communication device may be the same device, and need not be separate devices. Specific examples of portable transaction devices can include wearable devices, payment cards such as credit, debit, and prepaid cards, vehicles with remote communication capabilities, etc.

### DETAILED DESCRIPTION

Embodiments of the invention are directed to product design. More specifically, embodiments of the invention are directed to techniques for generating a product design model based on user characteristics and using the product design model to design multiple products for users that display those characteristics. As an illustration, in some embodiments of the invention, user feedback is obtained from a group of users that share a common set of characteristics (e.g., age, income bracket, gender). The user feedback is centered around (1) “features” (i.e., aspects, experiences, perceptions) that are associated with the set of common characteristics and (2) how important of each of the features are considered to be by participants of the feedback program.

For example, feedback regarding features associated with cars may be obtained from a group that is representative of a particular segment of the population (e.g., fifty individuals that are all middle-aged and have a college degree or higher). Such features may include: (1) a perception that a car prioritizes the safety of its occupants, (2) a perception that the car is nimble and/or maneuverable, (3) a perception that the car is powerful, (4) a perception that the car is comfortable, (5) a perception that the car is environmentally conscious, and (6) a perception that the car is stylish. The feedback may contain information describing how important the population segment considers each of the features to be. For instance, while college-educated middle-aged individuals may value cars that are both perceived to be stylish and perceived to prioritize safety, this population segment may place more importance on safety than stylishness.

The user feedback may be analyzed to determine a value for each feature, where the determined value for a feature represents the importance placed upon the feature by users displaying the set of common characteristics. For example, a server computer may analyze the feedback regarding the car-associated features and determine that, for college-educated middle-aged people, the importance of the perception that a car prioritizes the safety of its occupants may be represented by the value ‘12’ while that of the perception that the car is stylish may be represented by the value ‘5’. Stated another way, the two values may quantify (1) how much importance the population segment places on the car-associated features and (2) how much more the population segment values the safety feature over the stylishness feature. In some embodiments, the features may be categorized into a plurality of feature categories, where each category may be associate with a particular weight.

A server computer then uses the combination of the features and their associated values as a product design model to determine whether a product would be desirable to a user displaying the set of common characteristics. This product design model would be reusable in the sense that the server computer could independently evaluate multiple products using the combination of the features and their associated values. In particular, a server computer may receive, from a client computer, a set of product design components that are associated with a product that is being designed. Then, for each of the features, the server computer may then determine whether the set of product design components provides the feature (i.e., embodies the feature or satisfies the desired experience).

For example, a server computer may receive a set of design components chosen for a concept car, where the set of design components includes the concept car having a rear back-up camera and the concept car having a diesel engine. The server computer may then determine, based on the set of design components, which of the car-associated features this concept car would provide. In particular, the server computer may determine that because the concept car has a diesel engine, the concept car does not embody the perception that the car is environmentally conscious. The server computer may also determine that because the concept car has a rear back-up camera, the concept car does embody a perception that the car prioritizes the safety of its occupants.

The server computer then determines a set of selected values based on which features are provided by the set of product design components. For example, the determination that the concept car does embody the perception that the car prioritizes safety results in the feature's associated value, ‘12’, being included in the set of selected values while the determination that the concept car does not embody the perception that the car is environmentally conscious results in the feature's associated value not being included in the set of selected values.

In some embodiments, the server computer may then determine and output an overall score for the set of product design components based on the set of selected values. For example, a server computer may add up the set of selected values. In some embodiments, the weights associated with the feature categories may be applied to the values before the values are added together. The resulting score may represent the product's desirability to those displaying the set of common characteristics. For example, if a resulting score indicates that the concept car exceeds a threshold score for college educated middle aged people, the product may be evaluated against a number of other target population segments. If enough population segments find the concept car to be desirable, the concept car may be put into production.

As seen from the above example, certain embodiments of the invention may provide the following advantages.

If feedback is to be collected for multiple products that share a similar set of product design components and are intended to provide a common set of features, certain embodiments of the invention may substantially reduce the cumulative total amount of time spent obtaining feedback for the multiple products. Because the product design model is generated from the common set of features, this model may be reused for evaluating each of the products. Stated another way, user data and user feedback only needs to be gathered once to generated the product design model. Once the product design model is created, the product design model may be used to design and/or evaluated a plurality of products without needing to gather anymore user data or user feedback

Additionally, because the feedback is obtained prior to designing products, the viability of each product can be evaluated very early in the product's design process. By systematically using the product design model as a product viability threshold test and by eliminating non-viable products early in their design phases, designers may save additional time and effort.

Furthermore, by breaking the vague concept of a product's desirability into a set of concrete features and assigning point values to each of the features, certain embodiments of the invention may provide a more precise way to quantify the desirability of multiple proposed products. In doing so, certain embodiments of the invention may facilitate the ranking, sorting, and measuring of multiple proposed products.

### I. System For Generating And Using Product Design Models

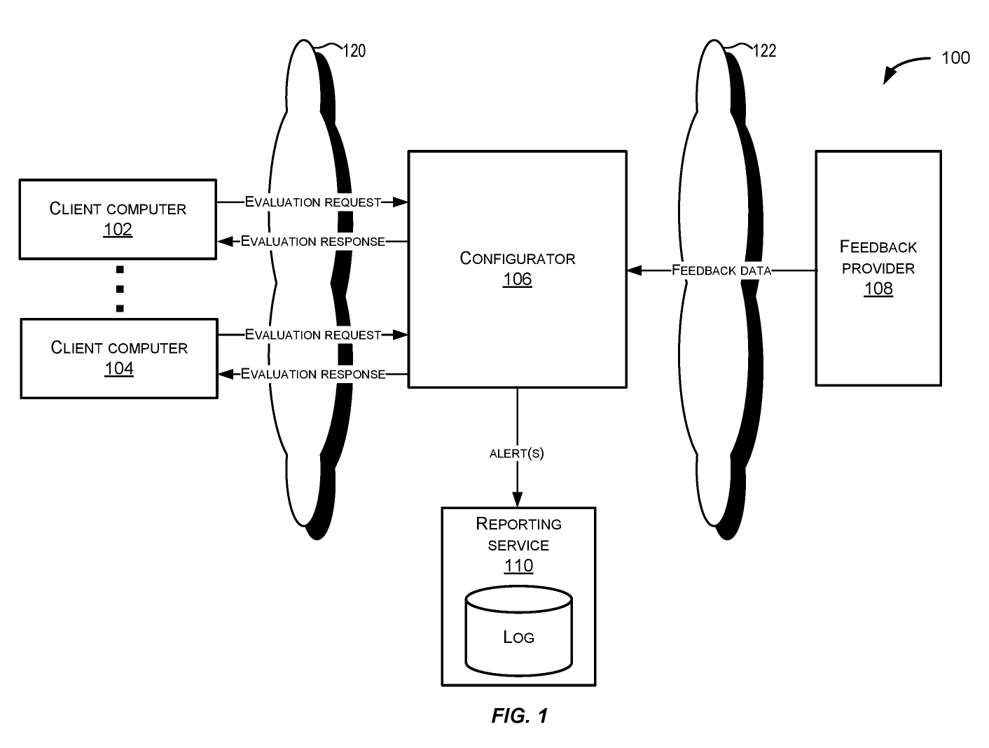

An exemplary system 100 for generating a product design model and using the model to design and/or evaluate multiple products can be seen in FIG. 1 The system 100 includes client computers 102-104, a configurator 106, a feedback provider 108, a reporting service 110, and communication network 120.

FIG. 1 shows the feedback provider 108 transmitting feedback data to the configurator 106 for analysis. In some embodiments, the feedback data may include feedback obtained through interactions with one or more participants that represent a targeted segment of the population within a feedback gathering effort. In some embodiments, upon the configurator 106 receiving feedback data associated with a particular population segment and a particular set of features, the configurator 106 analyzes the feedback data to determine set of values from the set of features.

Within the context of a relationship between a product and its user, a feature may correspond to a benefit or a desirable experience that is provided by the product to the user and/or perceived by the user from the product. For example, if the product is a car, one feature of the car may be a perception that the car prioritizes the driver's safety, where the perception is provided to the driver by one or more components (i.e., design components) designed into the car (e.g., backup camera, automatic seatbelts, side air bags, etc.). This perception may cause the car to become more desirable to the driver because the car makes the driver feel safer. In another example, if the product is an online advertisement, one feature of the online advertisement may be a perception that the online advertisement imparts a positive outlook, where the perception is provided by one or more components that are designed into the online advertisement (e.g., smiling actors, uplifting music, bright colors tones). This perception may cause the online advertisement to appear more compelling to the viewer because the online advertisement makes the viewer feel good.

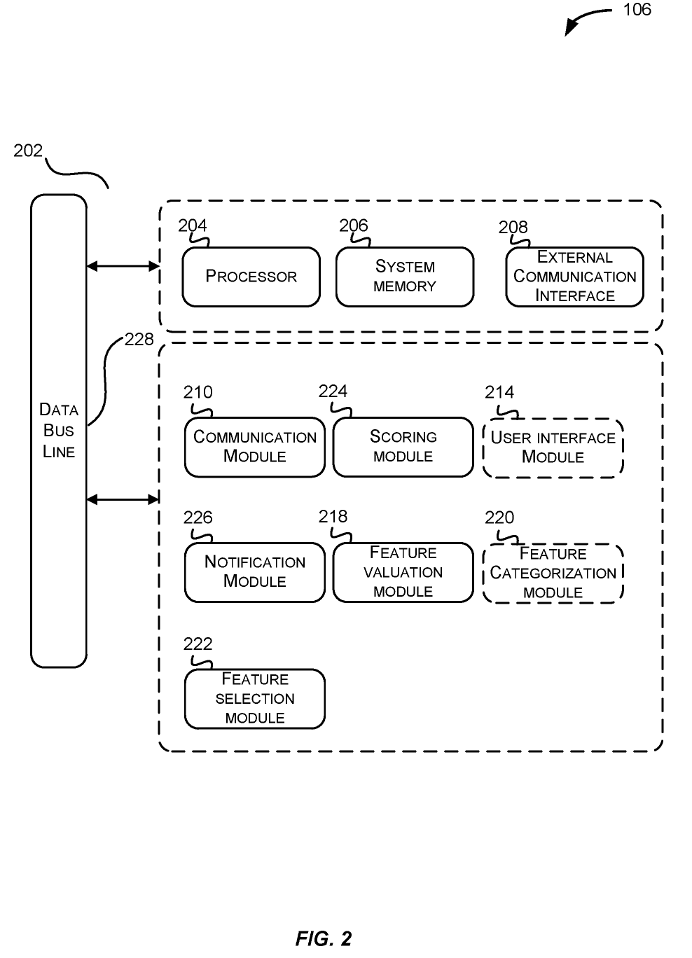

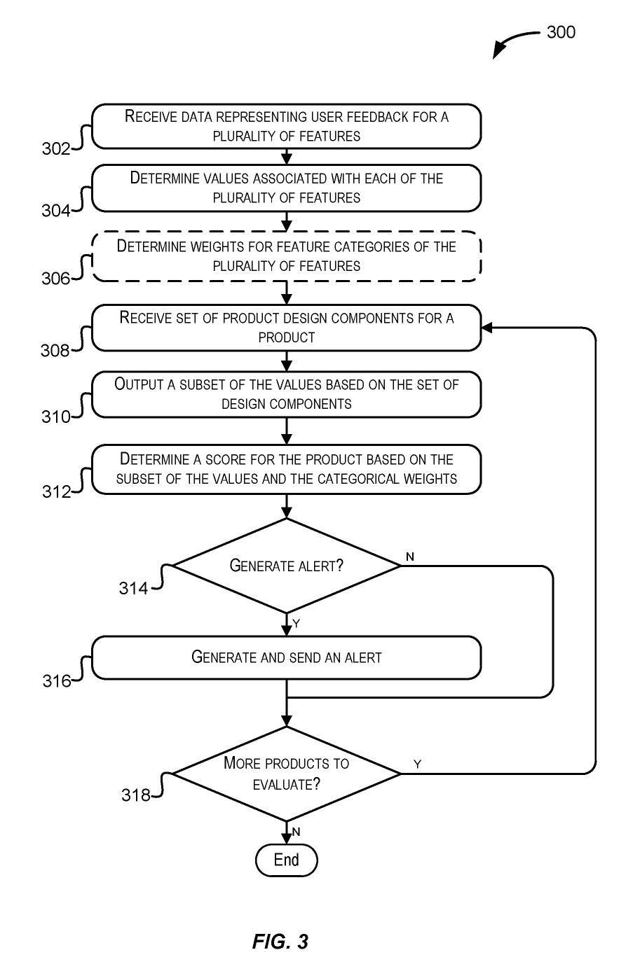

In some embodiments, human operators may manually determine values for the set of features based on the feedback data. In some embodiments, such features may be associated with one or more characteristics of a group of users that are being targeted by the product. In particular, the characteristics (e.g., age, gender, income bracket) of the targeted group may affect what value is determined for each feature because the characteristics of the targeted group may affect the feedback that is received from the group (e.g., older segments of the population place more importance in the perception of safety in cars). The steps of obtaining feedback data and determining values for the set of features are discussed in further detail below with respect to FIG. 2 and FIG. 3.

The feedback provider 108 may correspond to one or more computing devices that are configured to obtain the feedback data from one or more sources, store the feedback data, and/or provide the feedback data to the configurator 106 upon request. Once feedback data is gathered and provided to the feedback provider 108, the feedback provider 108 may store the feedback data (e.g., in a database, in memory) until the feedback data is ready to be received by the configurator 106 (e.g., over a network). It should be noted that certain embodiments may have the operator of system 100 provide the feedback data to the configurator 106 without the assistance of the feedback provider 108.

FIG. 1 also shows the client computers 102-104 each transmitting a set of design components to the configurator 106. Each set of design components that is received by the configurator 106 may correspond to a particular product that is being evaluated. In particular, a set of design components may include design components that are designed into a single product. For instances, if a concept car is to be evaluated by the configurator 106, the set of design components may include various components that may be designed into the car such as an exterior having a red color, a back-up camera, a diesel engine, etc. Additional examples of products and their respective design components are discussed below with respect to FIG. 3.

Upon receiving a set of design components for a product, the configurator 106 may determine which of the set features that were derived from the feedback data would be provided by a product that includes the set of design components. For each feature is determined to be provided by the set of design components, the configurator may select the value that is associated with the feature and add the selected value to a set of selected values, the set of selected values being the output. In certain interactive embodiments of the invention, human operators may manually determine which features are provided by the set of design components.

In some embodiments, the configurator may generate an overall score for the set of features based on the set of selected values, where the score represents an desirability of a product having the set of design components towards the population segment. As shown in FIG. 1, one or alerts may be generated in response to the evaluation of a set of design components. For example, if an overall score of the set of design components exceeds a threshold score, an alert may be generated and sent to a reporting service 110. The steps of evaluating a set of design components are discussed in further detail with respect to FIG. 2 and FIG. 3.

The client computers 102-104 may correspond to computing devices that are each communicatively coupled to the communication network 120 and are each configured to submit products to be evaluated by the configurator 106 (i.e., a product evaluation request). In some embodiments, different client computers may be operated by different organizations that are clients of the functionality provided by the configurator 106. The client computers 102-104 may each be configured to include, within each product evaluation request, a set of design components that are intended to be designed into the product. For example, if the client associated with client computer 102 intends to submit a concept car for evaluation, the client computer 102 may be configured to include the following design components within the evaluation request: an exterior having a red color, a back-up camera, a diesel engine.

The client computers 102-104 may each be configured to receive, from the configurator 106, a product evaluation response that is transmitted in response to a product evaluation request. The product evaluation response may comprise one or more outputs that are generated by the configurator based on the set of design components in the product evaluation request and the set of features and their associated values. In some embodiments, the product evaluation response may include a set of selected values or an overall score. The steps of generating the product evaluation response by the configurator 106 is discussed below in further detail with respect to FIGS. 2-3.

The client computers 102-104 may communicate with the configurator 106 over the communication network 120. The configurator 106 may communicate with the feedback provider 108 over the communication network 122. The communication networks 120-122 can be of various types and can include one or more communication networks. Examples of the communication networks 120-122 include, without restriction, the Internet, a wide area network (WAN), a local area network (LAN), an Ethernet network, a public or private network, a wired network, a wireless network, and the like, and combinations thereof. Different communication protocols may be used to facilitate the communications including both wired and wireless protocols such as IEEE 802.XX suite of protocols, TCP/IP, IPX, SAN, AppleTalk, Bluetooth, and other protocols. In general, the communication networks 120-122 may include any communication network or infrastructure that facilitates communications between computing devices

The configurator 106 may be communicatively coupled to the communication network 120 and to the communication network 122. Over the communication network 120, the configurator 106 may be configured to receive product evaluation requests from and transmit product evaluation responses to a plurality of client computers including the client computers 102-104. Over the communication network 122, the configurator 106 may be configured to receive feedback data from the feedback provider 108. For example, the configurator 106 may receive a product evaluation request from the client computer 102, generate a product evaluation response from the contents of the request, and transmit the product evaluation response to the client computer 102. The components of the configurator 106, according to some embodiments, are discussed in further detail below with reference to FIG. 2 and FIG. 3 respectively.

The configurator 106 may be communicatively coupled to the reporting service 110, which may be provided by one or more servers. The reporting service 110 may be configured to alerts from one or more reporting clients including the configurator 106. Accordingly, when the configurator 106 evaluates a product in response to a product evaluation request and determines that the evaluation results should be communicated to associated personnel, the configurator 106 may send an alert comprising the results and send the alert to the reporting service 110. For example, if the configurator 106 determines that an overall score of a product exceeds a threshold score, the configurator 106 may alert associated personnel about the viability of the product via the reporting service 110. Upon receiving an alert, the reporting service 110 may persist the alert in a log (e.g., in a file or a database) and/or trigger one or more notifications to the associated personnel.

Although FIG. 1 depicts the configurator 106, the feedback provider 108, and the reporting service 110 as separate physical components, this is not intended to be limiting. In embodiments where the configurator 106, the feedback provider 108, and the reporting service 110 are implemented using separate machines (e.g., separate computing devices, separate server clusters), the configurator 106, the feedback provider 108, and the reporting service 110 may be communicatively coupled via a communication network (e.g., a LAN, a WLAN, a VPN). In some alternative embodiments, the configurator 106, the feedback provider 108, and the reporting service 110 may execute on the same machine(s) (e.g., the same computing device, the same server cluster). For example, configurator 106, the feedback provider 108, and the reporting service 110 may be implemented in separate virtual machines or containers that execute on the same physical hardware. Regardless of how the configurator 106, the feedback provider 108, and the reporting service 110 are physically implemented, communications between the configurator 106, the feedback provider 108, and the reporting service 110 may network-based communications (e.g., Hypertext Transfer Protocol (HTTP), HTTP over Secure Socket Layer (SSL)).

### II. Configurator

FIG. 2 illustrates a block diagram of the configurator 106 including an exemplary server computer 202 in accordance with embodiments. The server computer 202 is illustrated as comprising a plurality of hardware and software modules (204-226). However, it should be appreciated that this is provided for illustration purposes only, and each of the modules and associated functionality may be provided and/or performed by the same or different components. That is, the server computer 202 may perform some of the relevant functions and steps described herein with reference to the configurator 106 through the use of any suitable combination of software instructions and/or hardware configurations. It should be noted that although FIG. 2 (and other system described herein) illustrates all of the modules located on a single device, the disclosure is not meant to be so limited. Moreover, a system for implementing the functionality described herein may have additional components or less then all of these components. Additionally, some modules may be located on other devices such as a remote server or other local devices that are functionally connected to the server computer component(s). In some cases, the software modules may be located on a virtual machine or a container.

The server computer 202 is shown as comprising a processor 204, system memory 206 (which may comprise any combination of volatile and/or non-volatile memory such as, for example, buffer memory, RAM, DRAM, ROM, flash, or any other suitable memory device), and an external communication interface 208. Moreover, one or more of the modules 210-226 may be disposed within one or more of the components of the system memory 206, or may be disposed externally. As was noted above, the software and hardware modules shown in FIG. 2 (and other systems described herein) are provided for illustration purposes only, and the configurations are not intended to be limiting. The processor 204, system memory 206 and/or external communication interface 208 may be used in conjunction with any of the modules described below to provide a desired functionality. Some exemplary modules and related functionality may be as follows:

A communication module 210 may be configured or programmed to perform some or all of the functionality associated with receiving, sending, and generating electronic messages for transmission through the configurator 106 to or from any of the entities shown in FIG. 1. When an electronic message is received by the server computer 202 via the external communication interface 208, it may be passed to the communication module 210. The communication module 210 may identify and parse the relevant data based on a particular messaging protocol used in the configurator 106. As examples, the received information may comprise identification information, authorization information, feedback information, design component information, and/or any other information that the configurator 106 may utilize in processing feedback data or product evaluation requests. The communication module 210 may then transmit any received information to an appropriate module within the server computer 202 (e.g., via a data bus line 228). The communication module 210 may also receive information from one or more of the modules in the server computer 202 and generate an electronic message in an appropriate data format in conformance with a transmission protocol used in the configurator 106 so that the message may be sent to one or more entities within system 100 (e.g., to one of the client computers 102-104 and the reporting service 110). The electronic message may then be passed to the external communication interface 208 for transmission. The electronic message may, for example, comprise a product evaluation response (e.g., to be transmitted to the client computer 102 via the communication network 120), an alert message (e.g., to be transmitted to the reporting service 110), or any other suitable electronic message used in the present context. In some embodiments, the communication module 210 may provide a

[symbol]

Optionally, the user interface (UI) module 214 may be programmed and/or configured to perform functionality associated with displaying a user interface to an client computers (e.g., client computer 102-104) to enable a human operator of the client computer to interact with the configurator 106. As mentioned previously, in response to receive a product evaluation request, an alternative embodiment of the invention may enable the operator to manually determine and select which features within a set of features are provided by a product having a set of design components. In this embodiment, the UI module 214 may communicate (e.g., via the communication module 210) a series of questions to the operator, where each of the questions is associated with one of the features. For example, the UI module may display a question that asks the operator whether the product in question provides a perception that the car prioritizes the safety of its occupants and provide UI control components that enable the human operator to answer yes or no. In some embodiments, the UI module may display the question to the operator in a web-based UI in a web browser that is installed on the client computer. For example, the UI module may generate a webpage, the webpage displaying a plurality of questions to the operator. The operator may select an answer to each of the questions and submit the webpage to transmit the answers to the configurator 106. In some embodiments, the UI module may display the question to the operator via a client application that is installed on the client computer. In some embodiments, the UI module 214 may be configured to communicate a product evaluation response to the operator once the response is generated.

The feature valuation module 218 may be programmed and/or configured to perform functionality associated with analyzing feedback data to determine a set of values for a set of features associated with the feedback data. The feature valuation module 218 may receive feedback data via the communication module 210 from the feedback provider 108. The feedback data may be provided in various formats including but not limited to: a flat text file, a comma-separated values (CSV) file, and a file comprising markup language (e.g. XML, JSON). The feedback data may comprise metadata associated with the feedback including but not limited to: information pertaining to the participants from which the feedback data was obtained (e.g., name, age, etc.), information pertaining to the population segment that is represented by the individuals (e.g., age range, income range, etc.), information about the feedback gathering program or effort (e.g., questions asked, dates of when the program was conducted, etc.), the set of features associated with the feedback, and information about the type of products to be evaluated using the feedback data (e.g., a product line).

The feedback contained within the feedback data may vary based on how the participants were interacted within during the feedback gathering program. In some embodiments, if the participants participated in surveys or questionnaires, the feedback may comprise answers to the surveys or the questionnaires. For example, if the feedback gathering program posed multiple-choice questions or true-or-false questions to the participants, the feedback may comprise multiple choice answers or true-or-false answers. These answers may be used by the feature valuation module to determine how much importance the population segment places on each of the features that were the focus of the feedback gathering program. For example, for a feedback gathering program that is conducted to determine what types of cars a population segment finds to be desirable, the survey may ask the participants questions such as “How important is it for a car to be environmentally conscious?” Accordingly, the answers to this question may include “great importance,” “moderate importance,” “little importance,” and “no importance.” In this example, the feature valuation module may gather the answers from all the participants to this question and feed the answers to a heuristic formula, where the formula returns a value for the feature “a perception that the car is environmentally conscious.” For instance, if the answers indicate that few participants consider environmental consciousness to be important within a car, the formula may assign a lower value to the feature. If the answers indicate that most participants consider environmental consciousness to be important within a car, the formula may assign a higher value to the feature.

In an alternative embodiment, human operators of the system 100 may manually determine values for the set of features. Once the values are manually determined, the operators may input the values into the configurator 106 via an (administrative) UI that is provided by the configurator 106.

Accordingly, once the feature valuation module determines values for the set of features based on the feedback data or receives manually determined values, the feature valuation module may provide the values to the scoring module 224. In embodiments where questions are to be displayed to an operator by the UI module 214, the feature valuation module may provide the set of features and their associated values to the UI module 214 so that the UI module 214 may generate questions to ask based on the set of features. In some embodiments, questions may be manually determined and provided to the UI module 214.

Optionally, the feature categorization module 220 may be programmed and/or configured to perform functionality associated with analyzing feedback data to categorize features into a plurality of features and/or to determine weights for each of the feature categories. As mentioned previously, a set of features may be categorized into feature categories and weights may be assigned to the feature categories. These weights may influence an overall score that is generated from the values associated with the set of features during the evaluation of a product. In some embodiments, the feature categorization module 220 may determine a weight for each of the feature categories based on the feedback data. For example, if the feature valuation module 218 determines that most of the features within a particular category are not considered to be important by the population segment, the feature categorization module 220 may determine a lower weight for the category.

In some embodiments, the categorization of the features may be performed manually by human operators. In such embodiments, the operators may input the feature categories and their features into the configurator 106 via an (administrative) UI that is provided by the configurator 106. In some embodiments, feature category weights may be performed manually by human operators. In such embodiments, the operators may input the feature categories and their associated weights into the configurator 106 via the UI.

The feature selection module 222 may be programmed and/or configured to perform functionality associated with selecting features from a set of features based on a set of product design components for a product. The feature selection module 222 may receive, via the communication module 210, a product evaluation request that comprises a set of design components that are designed into a product. Upon receiving the request, the feature selection module 222 may iterate through each feature within the set of features and, for each feature, determine whether the set of product design components provides the feature. In embodiments where the relationship between product design components and features are object, features may be programmatically selected by the feature selection module 222. For example, the feature selection module 222 may be configured to equate the inclusion of the following design components: a back-up camera and automatic seatbelts to the car providing the feature: a perception that the car prioritizes the safety of its occupants. Accordingly, if the feature selection module 222 determines that the set of design components in the product evaluation request includes a back-up camera and automatic seatbelts, the feature selection module 222 may select the feature: a perception that the car prioritizes the safety of its occupants.

As mentioned previously, if the relationship between product design components and features are subjective, an alternative embodiment may rely on a human operator to select features that are provided by the product that is being evaluated. In such embodiments, the product evaluation request that is sent by a client computer may omit the set of product design components. Rather, the product evaluation request may cause the feature selection module 222 to collaborate with the UI module 214 in asking a human operator of the client computer a series of questions to the operator, where each question asks the operator whether a feature within the set of features is provided by the product having the set of product design components. Once the UI module 214 receives answers to the series of questions, the answers are forwarded to the feature selection module 222. For each question that receives an affirmative answer, the feature selection module 222 selects the feature that is associated with the question.

Once the set of selected features are determined, the set of selected features may be provided to the scoring module 224 so that an overall score may be generated for the product.

The scoring module 224 may be programmed and/or configured to perform functionality associated with generating an overall score for a product based on the set of features that is determined to be provided by the product. After the feature selection module 222 determines a set of selected features in response to a product evaluation request, the feature selection module 222 may provide the set of selected features to the scoring module 224. The scoring module 224 may then generate an overall score from the values associated with the set of selected features. Stated another way, any feature that is determined by the feature selection module 222 to be provided by the product contributes its associated value to the overall score. Features that are determined not to be provided by the product contribute nothing to the overall score. The scoring module 224 may then feed the values to a predefined formula to determine the overall score. For example, the scoring module 224 may add the values together to obtain the overall score.

Some embodiments may include categorizing the features into a plurality of feature categories, where category may have a weight that affects the overall score. For example, the scoring module 224 may, for each category, obtain the sum of the values of the features in the category to obtain a category-specific score, apply the category's weight to the category-specific total (e.g., by multiplying the category's weight with the category-specific total) to obtain a weighted category-specific score. The scoring module 224 may then add all of the weighted category-specific totals to obtain an overall score.

A notification module 226 may be programmed and/or configured to perform functionality associated with generating and transmitting alerts to a reporting service (e.g., reporting service 110). For example, if the scoring module 224 determines an overall score for a product that exceeds a threshold score, the scoring module 224 may cause the notification module 226 to generate an alert message that encapsulates information about the product and its design components. The notification module 226 may transmit the alert message to the reporting service 110.

### III. Using a Product Design Model

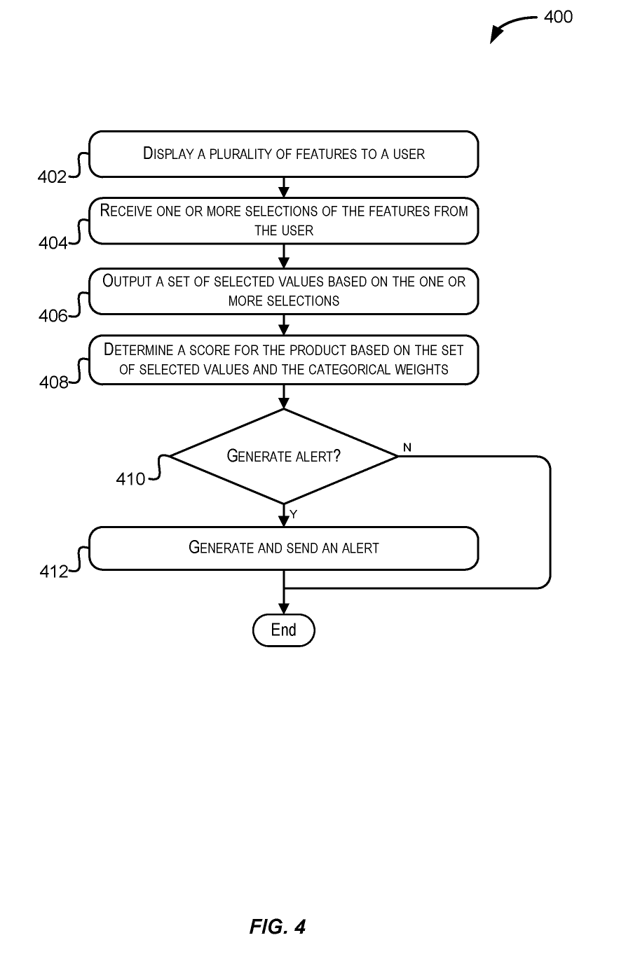

FIGS. 3 and 4 show flowcharts illustrating methods 300 and 400 in accordance with some embodiments. The steps of methods 300 and 400 may be performed by the server computer 202 of the configurator 106.

FIG. 3 shows a flowchart illustrating an exemplary method 300 of generating and using a product design model in accordance with embodiments.

At step 302, the configurator 106 receives data representing user feedback regarding a plurality of features from feedback provider 108. In some embodiments, an organization (e.g., a company) may obtain the feedback from a feedback gathering program involving a group of participants that share a set of common characteristics (e.g., age, profession, gender, income bracket, educational level, etc.). The group of participants may be selected to represent a particular segment of the population. For example, if the targeted population segment are college-educated middle-aged people, the group of participants may comprise individuals that are middle-aged and possess at least a college degree.

In some embodiments, the feedback may be obtained through questionnaires, surveys, or interviews with the participants. In particular, the questionnaires may be centered on features that are relevant to the type of products that are to be offered by the organization. The questions may be designed to gain insight into how much importance the participants place on each of the features. These insights can be used to determine which sets of product-related features would seem desirable to the population segment if the set of features were designed into a single product.

For example, if the organization designs cars, the questions may revolve around features that consumers find relevant to cars including but not limited to: (1) a perception that a car prioritizes the safety of its occupants, (2) a perception that the car is nimble and/or maneuverable, (3) a perception that the car is powerful, (4) a perception that the car is comfortable, (5) a perception that the car environmentally conscious, and (6) a perception that the car is stylish.

If the organization designs university course curriculums, the questions may revolve around features that students find relevant to educational classes including but not limited to: (1) a perception that the course imparts practical knowledge rather than theory, (2) a perception that the course rigorously tests the students, (3) a perception that the course prioritizes interaction between the teacher and the students, and (4) a perception that the course uses up-to-date technology and teaching methodologies

If the organization generates advertisements, the questions may revolve around features that viewers find relevant to advertisements including but not limited to: (1) a perception that the advertisement is sensitive to contemporary social issues, (2) a perception that the advertisement is concise, (3) a perception that the advertisement is appropriate for a larger selection of age ranges, (4) a perception that the advertisement is hip and cool, and (5) a perception that the advertisement imparts a positive outlook.

If the organization generates portable transaction devices, the questions may revolve around features that viewers find relevant to payment transactions including but not limited to: (1) a perception that the device issuer is keeping their money secure, (2) a perception that the user is likely to obtain approval to use the device, (3) a perception that the process of recovering a lost device is smooth, (4) a perception that the user is catered to with relevant offers, rewards, and discounts, and (5) a perception that the device issuer will provide greater insight into the user's behavior patterns.

At step 304, the configurator 106 determines values associated with each of the plurality of features based on the feedback data. As mentioned previously, in embodiments where the feedback comprises answers to surveys, values for each of the features may be programmatically determined based on the answers.

For a feedback gathering program that is conducted to determine what types of advertisements a population segments finds to be desirable, the questions within the survey may include: “Would the perception that the advertisement imparts a positive outlook make the advertisement more compelling?” Accordingly, the answers to this question may include “yes” and “no.” In this example, if the configurator 106 determines that the answers to this question are usually yes, the configurator 106 may assign a higher value to the feature: the perception that the advertisement imparts a positive outlook.

For a feedback gathering program that is conducted to determine what types of cars a population segment finds to be desirable, the questions within the survey may include: “How important is it for a car to be environmentally conscious?” Accordingly, the answers to this question may include “great importance,” “moderate importance,” “little importance,” and “no importance.” In this example, if the answers indicate that few participants consider environmental consciousness to be important for a car, the formula may assign a lower value to the feature: the perception that the car environmentally conscious. For example, the configurator 106 may analyze the feedback regarding the car-associated features and determine that, for college-educated middle-aged people, the importance of the perception that a car prioritizes the safety of its occupants may be represented by the value ‘12’, the importance of the perception that the car is nimble and/or maneuverable may be represented by the value ‘8’, the importance of the perception that the car is powerful may be represented by the value ‘4’, the importance of the perception that the car is comfortable may be represented by the value ‘16’, the importance of the perception that the car is environmentally conscious may be represented by the value ‘7’, and the importance of the perception that the car is stylish may be represented by the value ‘5’.

Optionally, at step 306, the configurator 106 determines weights for feature categories of the plurality of features. As mentioned previously, the plurality of features may be categorized into a plurality of feature categories.

In the example above involving advertisements, the features: a perception that the advertisement is sensitive to contemporary social issues, a perception that the advertisement is hip and cool, and a perception that the advertisement imparts a positive outlook may be categorized under an “advertisement tone” category while the features: a perception that the advertisement is concise and a perception that the advertisement is appropriate for a larger selection of age ranges may be categorized under an “advertisement accessibility” category.

In the example above involving cars, the features: a perception that a car prioritizes the safety of its occupants, a perception that the car is nimble and/or maneuverable, a perception that the car is powerful may be categorized under a “drivability” category while the features: a perception that the car is environmentally conscious and a perception that the car is stylish may be categorized under an “image” category. In this example, the drivability category and the image category may be associated with the weights ‘0.75’ and ‘0.50’ respectively.

In yet another example related to the design of a portable transaction device, the feature categories may include a first category associated with product usability, a second category associated with product security, a third category associated with product adoptability, and a fourth category associated with product style.

In some embodiments, the configurator 106 may programmatically determine weights for each of the categories based on the feedback.

At step 308, the configurator 106 receives a set of product design components that describe a product. In particular, the configurator 106 may receive, from a client computer (e.g., one of client computers 102-104), a product evaluation request comprising the set of product design components. Upon receiving the product evaluation request, the configurator may iterate through each feature within the set of features and, for each feature, determine whether the set of product design components provides the feature. Any feature that is determined to be provided by the set of product design components is selected.

In the example above involving cars, the set of product design components may include the car having a rear back-up camera, the car having a diesel engine, the car having plastic seats, the car having side-impact airbags, the car having automatic seatbelts, the car being a full-size van, and the car not including an air-conditioning (AC) system.

At step 310, the configurator 106 outputs a subset of the values of the features based on the set of design components for the product. In particular, the configurator 106 may select the values of the features that were selected in step 308. In some embodiments, the configurator 106 may provide the subset of the values as output, where the subset of the values may be used in a subsequent determination of whether the product in question is viable or worth pursuing. In other embodiments, the subset of the values may be used to generate an overall score for the product.

In the example above involving cars, the configurator 106 may determine, based on the car having a rear back-up camera, the car having a diesel engine, the car having powered leather seats, the car having side-impact airbags, the car having automatic seatbelts, the car being a full-size van, and the car including a dual-zone air-conditioning (AC) system, that the car (1) provides a perception of prioritizing the safety of its occupants, (2) does not provide a perception of nimbleness and/or maneuverability, (3) provides a perception of having power, (4) provides a perception of comfort, (5) does not provide a perception of being environmentally conscious, and (6) does not provide a perception of being stylish. Thus, the configurator 106 may select the value associated with the first feature, which is ‘12’, the value associated with the third feature, which is ‘4’, and the value associated with the fourth feature, which is ‘16’. Accordingly, the subset of the values for the car may include the values ‘12’, ‘4’, and ‘16’.

At step 312, the configurator 106 determines an overall score for the product based on the subset of the values and, optionally, the categorical weights. In particular, the configurator 106 may feed the subset of the values to a predefined formula to determine the overall score. For example, the configurator 106 may add the values together to obtain the overall score. In embodiments where the features are categorized, the category weights may affect the overall score. For example, the configurator 106 may, for each category, obtain the sum of the values of the features in the category to obtain a category-specific score, multiply the category-specific total by the category's weight to obtain a weighted category-specific score. The configurator 106 may then add all of the weighted category-specific totals to obtain an overall score. In the example above involving cars, the overall score for the car may be obtained by (1) adding ‘12’ and ‘16’ to obtain ‘28’, (2) multiplying ‘28’ by ‘0.75’ to obtain ‘21’, (3) multiplying ‘4’ by ‘0.5’ to obtain ‘2’, and (4) adding ‘21’ and ‘2’ to obtain ‘23’.

At decision 314, the configurator 106 determines whether generating an alert is justified based on the overall score. For example, if the configurator 106 determines that the overall score exceeds a threshold score, the configurator 106 may decide to generate and send an alert that identifies the product associated with the overall score. In the example above involving cars, if the threshold score is ‘20’, an alert may be generated and sent because the overall score ‘23’ exceeds the threshold score ‘20’. In embodiments where multiple products are evaluated and a score is obtained for each of the products, the configurator 106 may rank the scores of the products and decide to generate and send an alert that identifies the product associated with the highest ranked score.

At step 316, the configurator 106 generates an alert and sends the alert to reporting service 110. Upon receiving an alert, the reporting service 110 may persist the alert in a log (e.g., in a file or a database) and/or trigger one or more notifications to the associated personnel. As a result of the notifications, the organization may move forward with producing or promoting the product in question. In the example above involving cars, the generation and sending of the alert may cause the evaluated car design to enter production. In some embodiments where multiple scores are ranked, the proposed product with the highest score may be selected for production.

At decision 318, the configurator 106 determines whether there are more products to evaluate. As mentioned previously, one of the advantages of using a product design model based upon the set of features and their associated weights is that the product design model may be reused to evaluate a plurality of products that can comprise one or more of the set of features. Accordingly, if the configurator 106 receives another product valuation request comprising a subsequent set of design components for a subsequent product, the configurator 106 may return to step 308 to evaluate the subsequent product.

For example, if the configurator receives a second product valuation request where the second request includes a second set of product design components (which may describe a second product), the configurator 106 may iterate through each feature within the set of features and, for each feature, determine whether the second set of product design components provides the feature. Any feature that is determined to be provided by the second set of product design components is selected. Next, the configurator 106 may output a second subset of the values based on the second set of design components for the product. The configurator 106 may then determine a second overall score for the product based on the second subset of the values and, optionally, the categorical weights. If the configurator determines that generating a second alert is justified based on the second overall score, the configurator 106 may generate the second alert and send the second alert to reporting service 110.

FIG. 4 shows a flowchart illustrating an exemplary method 400 of using an interactive product design model in accordance with embodiments. As mentioned previously, certain embodiments of the invention may involve a human operator that manually interacts with the product design model to evaluate a product.

At step 402, the configurator 106 displays a plurality of features to a user. In particular, the configurator 106 may cause a client computer that is operated by the operator to display a UI containing a series of questions. Each of the questions may query the operator as to whether the product in question provides the feature. In response to each of the questions, the operator may consider, based on the operator's knowledge of the product and the product's design components, whether the product provides the feature in question. The operator would then provide an answer to each of the questions via the UI.

At step 404, the configurator 106 receives one or more selections of the features from the user. In particular, the configurator 106 may select each feature of the set of features that is designated by the operator as being provided by the product in question.

At step 406, the configurator 106 outputs a set of selected values based on the one or more selections. At step 408, the configurator 106 determines an overall score for the product based on the set of selected values and, optionally, categorical weights. At decision 410, the configurator 106 determines whether generating an alert is justified based on the overall score. At step 412, the configurator 106 generates and alert and sends the alert to reporting service 110.

The various participants and elements described herein with reference to FIGS. 1-4 may operate one or more computer apparatuses to facilitate the functions described herein. Any of the elements in FIGS. 1-4, including any servers or databases, may use any suitable number of subsystems to facilitate the functions described herein.

Examples of such subsystems or components are interconnected via a system bus. Additional subsystems such as a printer, keyboard, fixed disk (or other memory comprising computer readable media), monitor, which is coupled to a display adapter, and others are shown. Peripherals and input/output (I/O) devices, which couple to I/O controller (which can be a processor or other suitable controller), can be connected to the computer system by any number of means known in the art, such as a serial port. For instance, serial port or an external interface can be used to connect computer apparatus to a wide area network such as the Internet, a mouse input device, or a scanner. The interconnection via system bus allows a central processor to communicate with each subsystem and to control the execution of instructions from a system memory or fixed disk, as well as the exchange of information between subsystems. System memory and/or fixed disk may embody a computer readable medium.

Further, while the present invention has been described using a particular combination of hardware and software in the form of control logic and programming code and instructions, it should be recognized that other combinations of hardware and software are also within the scope of the present invention. The present invention may be implemented only in hardware, or only in software, or using combinations thereof.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

Any of the methods described herein may be totally or partially performed with a computer system including one or more processors, which can be configured to perform the steps. Thus, embodiments can be directed to computer systems configured to perform the steps of any of the methods described herein, potentially with different components performing a respective steps or a respective group of steps. Although presented as numbered steps, steps of methods herein can be performed at a same time or in a different order. Additionally, portions of these steps may be used with portions of other steps from other methods. Also, all or portions of a step may be optional. Additionally, any of the steps of any of the methods can be performed with modules, units, circuits, or other means for performing these steps.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method comprising:
receiving, by a processor, data representing user feedback from a group of users regarding a plurality of features, the plurality of features associated with characteristics of the group of users;
determining, by the processor, values associated with the plurality of features based on the data;
receiving, by the processor, a first set of product design components;
outputting, using the processor, a first subset of the values, the first subset of the values being selected based on the first set of product design components;
receiving, by the processor, a second set of product design components; and
outputting, using the processor, a second subset of the values, the second subset of the values being selected based on the second set of product design components.

2. The method of claim 1, wherein:
each design component of the first set of product design components describes a first product; and
each design component of the second set of product design components describes a second product.

3. The method of claim 2, further comprising:
determining, by the processor, a first score for the first set of product design components based on the first subset of the values; and
determining, by the processor, a second score for the second set of product design components based on the second subset of the values.

4. The method of claim 3, further comprising:
determining, by the processor, whether the first score exceeds a threshold score;
responsive to determining that the first score exceeds the threshold score, generating, by the processor, a first alert that identifies the first product;
determining, by the processor, whether the second score exceeds the threshold score; and
responsive to determining that the second score exceeds the threshold score, generating, by the processor, a second alert that identifies the second product.

5. The method of claim 3, further comprising:
ranking, by the processor, the first score and the second score; and
generating, by the processor, an alert that identifies a product associated with a higher of the first score and the second score, wherein the product is the first product or the second product.

6. The method of claim 3, further comprising:
categorizing, by the processor, the plurality of features into a plurality of categories; and
determining, by the processor, weights for the plurality of categories based on the characteristics of the group of users;
wherein determining the first score comprises applying the weights to the first subset of the values based on which of the plurality of categories each of the first subset of the values is categorized into.

7. The method of claim 6, wherein the plurality of categories comprises:
a first category associated with product usability;
a second category associated with product security;
a third category associated with product adoptability; and
a fourth category associated with product style.

8. The method of claim 1, wherein selecting the first subset of the values based on the first set of product design components comprises, for each of the first subset of the values:
determining whether a feature associated with the value is provided by the first set of product design components; and
responsive to determining that the feature is provided by the first set of product design components, selecting the value.

9. A computer comprising:
a processor; and
a computer-readable medium coupled to the processor, the computer-readable medium including code executable by the processor for performing a method comprising:
receiving data representing user feedback from a group of users regarding a plurality of features, the plurality of features associated with characteristics of the group of users;
determining values associated with the plurality of features based on the data;
receiving a first set of product design components; outputting, using the processor, a first subset of the values, the first subset of the values being selected based on the first set of product design components;
receiving a second set of product design components; and
outputting a second subset of the values, the second subset of the values being selected based on the second set of product design components.

10. The computer of claim 9, wherein:
each design component of the first set of product design components describes a first product; and
each design component of the second set of product design components describes a second product.

11. The computer of claim 10, wherein the method further comprises:
determining a first score for the first set of product design components based on the first subset of the values; and
determining a second score for the second set of product design components based on the second subset of the values.

12. The computer of claim 11, wherein the method further comprises:
determining whether the first score exceeds a threshold score;
responsive to determining that the first score exceeds the threshold score, generating a first alert that identifies the first product;
determining whether the second score exceeds the threshold score; and
responsive to determining that the second score exceeds the threshold score, generating a second alert that identifies the second product.

13. The computer of claim 11, wherein the method further comprises:
ranking the first score and the second score; and
generating an alert that identifies a product associated with a higher of the first score and the second score.

14. The computer of claim 11, wherein the method further comprises:
categorizing the plurality of features into a plurality of categories; and
determining weights for the plurality of categories based on the characteristics of the group of users;
wherein determining the first score comprises applying the weights to the first subset of the values based on which of the plurality of categories each of the first subset of the values is categorized into.

15. The computer of claim 14, wherein the plurality of categories comprises:
a first category associated with product usability;
a second category associated with product security;
a third category associated with product adoptability; and
a fourth category associated with product style.

16. The computer of claim 9, wherein selecting the first subset of the values based on the first set of product design components comprises, for each of the first subset of the values:
determining whether a feature associated with the value is provided by the first set of product design components; and
responsive to determining that the feature is provided by the first set of product design components, selecting the value.

17. A computer comprising:
a processor; and
a computer-readable medium coupled to the processor, the computer-readable medium including code executable by the processor for performing a method comprising:
displaying, to a user, a plurality of features, wherein the plurality of features are associated with characteristics of a group of users and each of the plurality of features is associated with a value based on data representing user feedback from the group of users;
receiving, from the user, one or more selections of the plurality of features on behalf of a set of one or more product design components;
determining, based on the values associated with the one or more selected features, a score for the set of one or more product design components;
determining whether the score exceeds a threshold score; and
responsive to determining that the score exceeds the threshold score, generating an alert that identifies the set of one or more product design components.

18. The computer of claim 17, wherein each design component of the set of one or more product design components describes a product.

19. The computer of claim 17, wherein the method further comprises:
categorizing the plurality of features into a plurality of categories; and
determining weights for the plurality of categories based on the characteristics of the group of users;
wherein determining the score comprises applying the weights to the values associated with the one or more selected features based on which of the plurality of categories each of the one or more selected features is categorized into.

20. The computer of claim 18, wherein the plurality of categories comprises:
a first category associated with product usability;
a second category associated with product security;
a third category associated with product adoptability; and
a fourth category associated with product style.
